(19) United States
(12) Patent Application Publication
(10) Pub. No.: US 2005/0118551 A1
(43) Pub. Date: Jun. 2, 2005

(54) Method and apparatus for delivering dental anesthetic

(76) Inventors: Michael I. Falkel, Camel Highlands, CA (US); Fred B. Blodgett, Cameron Park, CA (US)

Correspondence Address: G. TURNER MOLLER, JR., 711 NORTH CARANCAHUA, SUITE 720, CORPUS CHRISTI, TX, 78475, US

(21) Appl. No.: 10/969,421

(22) Filed: Oct. 20, 2004

Related U.S. Application Data
(60) Provisional application No. 60/512,409, filed on Oct. 20, 2003.

(51) Int. Cl. A61G 17/02

(52) U.S. Cl. 433/80

(57) ABSTRACT

Anesthetic is delivered in a substantially continuous manner through a hole drilled in a jaw bone of a dental surgery patient. The hole is drilled in a conventional manner and a fixture embedded in the bone. An adapter is attached to the fixture and anesthetic is delivered substantially continuously through a tube connected to the adapter. An interference fit between the fixture and the adapter provides a liquid seal. The tube may be connected to the fixture by an interference fit, by adhesive or by molding.

This application is based on provisional application Ser. No. 60/512,409, filed Oct. 20, 2003 for which priority is claimed.

This invention relates to a method and apparatus for efficiently delivering a dental anesthetic into the jaw bone of a patient in a simple, convenient manner.

### BACKGROUND OF THE INVENTION

One known technique for anesthetizing dental surgery patients is to drill a small hole in the jaw bone of the patient, leaving a fixture embedded in the bone. Anesthetic is injected into the bone with a syringe inserted through the fixture. Patents disclosing this technique are found in U.S. Pat. Nos. 6,247,928; 6,287,114; 6,273,715; 6,575,745; and 6,547,561 to which reference is made for a more complete description of the technique. This technique is very desirable because it delivers anesthetic immediately adjacent a tooth to be worked on so the nerve ending adjacent the tooth is deadened in contrast to the situation where a nerve trunk, leading to an entire section of the jaw, is blocked. After surgery, the patient may realize that something is odd in the mouth but will not have a numb cheek or numb tongue after an intraosseous anesthetic procedure. Another important advantage of this technique is speed. Anesthetic delivered through a properly positioned fixture will induce profound anesthesia in the time it takes to lay the syringe down and pick up a drill or other surgical instrument. In other words, almost immediately for all practical purposes.

Other disclosures of interest relative to this invention are found in U.S. Pat. Nos. 4,755,173; 5,176,662; 5,257,980; 5,372,583; 6,017,328; 6,358,252; 6,458,117 and 6,685,674.

### SUMMARY OF THE INVENTION

Long experience with the devices and technique disclosed in the above patents has led to the conclusion that anesthetics delivered into bone are subject to relatively rapid metabolization leading to unduly short periods of effectiveness. Medical people describe the cause as being due to the vascularity of the bone into which the anesthetic is injected. Those skilled in chemistry describe the cause as being due to the large surface area of the bone which catalyzes the metabolizing reactions. In fact, these descriptions differ only in terminology and are in fact describing the underlying cause in the jargon of different professions.

The short duration of profound anesthesia has unduly limited the clinical use of intraosseous anesthetic delivery because most procedures require more time to complete than is allowed by the overly rapid metabolization of anesthetic. The only current solution is to inject additional anesthetic with a syringe through the fixture remaining on the patient. Access to the end of the fixture is difficult because the fixture is inside the patient's mouth and inserting the hypodermic needle into the fixture can be challenging. To a layman, the size of the fixture is startling small. A typical prior art fixture that is embedded in the patient is no more than about ¼ inch in diameter and extends a similar distance out of the patient's gum. The diameter of the passage through which the needle of a syringe must pass is vanishingly small. In addition, the surgeon never has a straight shot at the passage through the fixture, meaning that the surgeon has to bend the needle to get it to enter the fixture. The combination of a small target located inside the patient's mouth at an odd angle is a challenge.

In addition, there is always a question of how much anesthetic to inject into the patient. Patients differ in their tolerance for, and reaction to, anesthetics. Injecting batches or slugs of anesthetic into a patient's bone to prolong profound anesthesia is not a desirable, much less optimum, technique.

In this invention, anesthetic is delivered substantially continuously into the bone of the patient from a time preceding the onset of surgery until a time near the end of surgery. The surgeon determines when it is appropriate to commence surgery and determine when it is appropriate to terminate delivery of anesthetic to the patient.

This may be accomplished in one of two ways. An adapter may be provided to fit onto commercially available devices used to drill bone and inject anesthetics or an original equipment device may be provided.

It is accordingly an object of this invention to provide an improved method and apparatus for delivering anesthetics into the bones of dental surgery patients.

A further object of this invention is to provide an improved technique for anesthetizing a dental surgery patient allowing the surgeon a choice of techniques for delivering anesthetic.

A more specific object of this invention is to provide an improved technique for delivering anesthetics into the bones of dental surgery patients in a simple expeditious manner that provides longer effective periods of profound anesthesia.

These and other objects and advantages of this invention will become more apparent as this description proceeds, reference being made to the accompanying drawings and appended claims.

### BRIEF DESCRIPTION OF THE DRAWINGS

FIGS. 1 and 2 are isometric views of a prior art device used to drill and embed a fixture in the jaw of a patient;

FIG. 3 is an exploded pictorial view of this invention in use;

FIG. 4 is a bottom view of one embodiment of this invention;

FIG. 5 is a cross-sectional view of the embodiment of FIG. 4, taken substantially along line 5—5 thereof, as viewed in the direction indicated by the arrows:

FIG. 6 is an end view of the embodiment of FIGS. 4-5;

FIG. 7 is a cross-sectional view of the assembled adapter of this invention and a prior art fixture;

FIG. 8 is a cross-sectional view, similar to FIG. 5, of another adapter of this invention; and

FIG. 9 is a cross-sectional view, similar to FIG. 7, of another embodiment of this invention.

### DETAILED DESCRIPTION

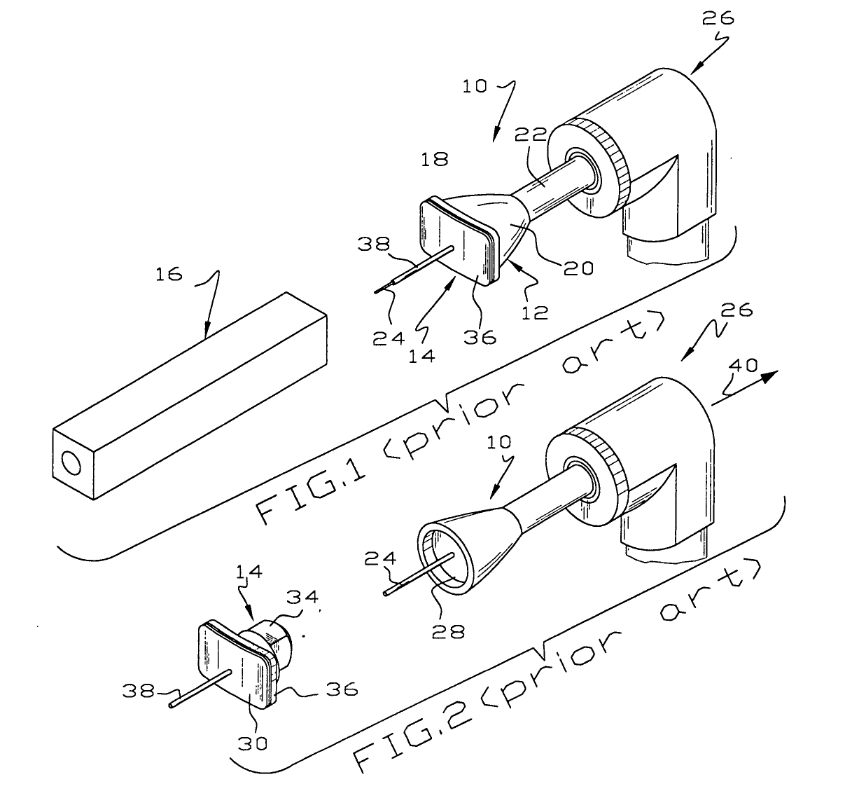

In this invention, conventional techniques are used to drill holes in the jaw bones of dental surgery patients from the inside of the patient's mouth using commercially available equipment and fixtures, such as are available from Tulsa Dental Products, Inc. of Tulsa, Okla. under the tradename X-TIP. As shown in FIGS. 1-2, a conventional anesthetic delivery apparatus 10 comprises, as major components, a drilling member 12 and a fixture 14 shipped on the end of a protective attachment or protective sheath 16 such as a plastic tube. The drilling member 12 includes a housing 20, a shaft 22, a solid or hollow drill or stylet 24 embedded in the shaft 22 and extending through the drill housing 20 and a connecting end (not shown) received in and driven by a conventional dental drilling apparatus 26. The inside of the housing 20 provides a drive connection 28 as shown best in FIG. 2.

The fixture 14 comprises a body 30 having a flange 32, a driven connection 34 for receipt by the connection 28, a flange 36 and a hollow sleeve or cannula 38 extending away from a flat central portion of the body 30. Although the cannula 38 is metal, the body 30 is a medical grade polymer, typically a high density polymer, which has an important contribution as discussed hereinafter. The body 30 may be of any suitable configuration such as circular, rectangular or oblong. Although the drive connections 28, 34 are illustrated as being of square cross-section, other suitable shapes are equally operative, such as other polygons, such as rectangles, pentagons, hexagons or the like.

In use, the surgeon drills a hole in the jaw bone of the patient from the inside of the patient's mouth, using the dental drill 26 as a power source, gently pushing on the flange 36 in any suitable manner. Operation of the dental drill assembly 26 causes both the cannula 38 and stylet 24 to rotate, creating a hole in the patient's gum and underlying bone. When the flat central portion of the body 30 contacts the patient's gum, drilling stops. The drilling member 10 and dental drill assembly 26 are retracted as shown by the arrow 40 in FIG. 2, leaving the fixture 14 embedded in the patient's jaw due to the slight elasticity of the bone. The stylet 24 preferably extends beyond the end of the cannula 38. A major function of the stylet 24 is to prevent the inside of the cannula 38 from being plugged with debris. Those skilled in the art will recognize the drilling member 10, the fixture 14 and the dental drill assembly 26 as exemplary of prior art assemblies used in preparation for intraosseous delivery of anesthetic.

Any suitable or approved anesthetic may be used in the practice of this invention. A current preferred anesthetic is lidocaine although those skilled in the art will recognize that others are also suitable and usable.

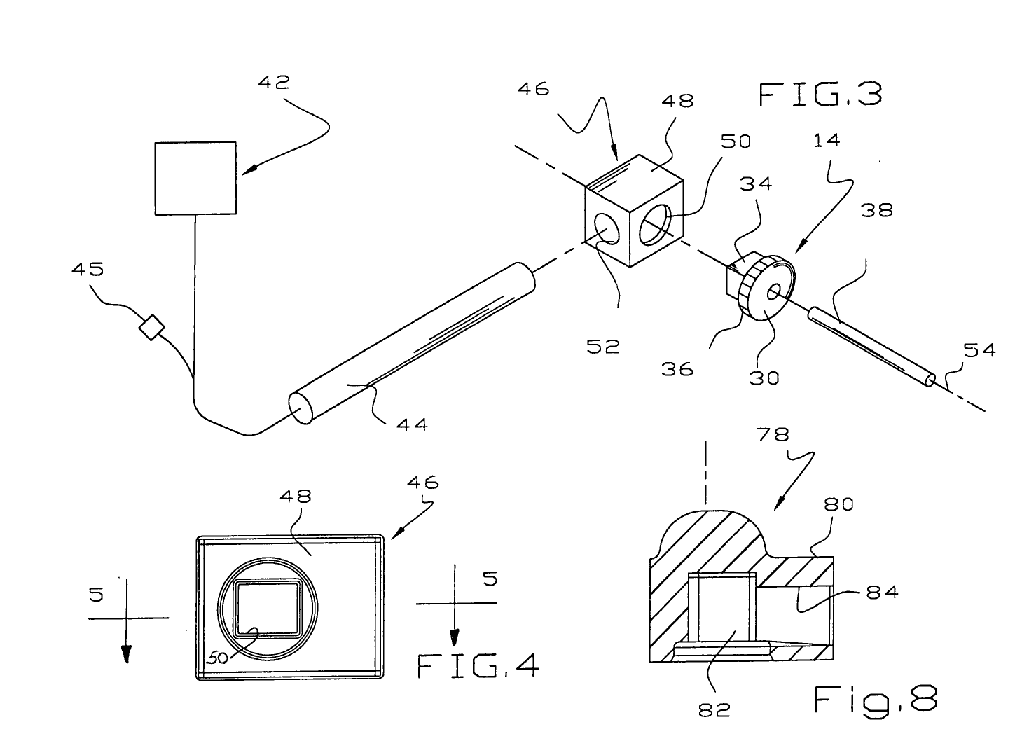

An important feature of this invention is substantially continuously delivering anesthetic into the jaw bone of the patient beginning before the onset of surgery and terminating near the end of surgery. As shown in FIG. 3, the technique for accomplishing this is to provide a source 42 for delivering anesthetic in a substantially continuous manner. This may be accomplished in any suitable fashion, as by providing a pump or IV bag and drip regulator (not shown) as the source 42 delivering anesthetic to a tube 44 connected to the fixture. At the onset of anesthetic delivery, a relatively large quantity or bolus of anesthetic is delivered to induce profound anesthesia. The exact initial quantity depends somewhat on the particular anesthetic, but with the preferred anesthetic lidocaine, the initial amount is on the order of about one cubic centimeter.

Thereafter, the rate of anesthetic delivery is relatively slow, particularly when compared to the initial dose or bolus. Again, the exact subsequent quantity may depend somewhat on the particular anesthetic. The rate is less than the initial quantity over a period of not more than five minutes and typically much less, such as 1/10th cubic centimeter over a period of five minutes. The subsequent anesthetic may be delivered in one or more small spurts, as with a pump, or more evenly with an IV bag and drip regulator at an appropriate elevation above the fixture.

When using a conventional pump, it is relatively simple to inject an initial measured quantity of anesthetic followed by a relatively slow trickle. When using an IV bag and drip regulator, the initial dose or bolus of anesthetic is delivered by a syringe through a diaphragm port 45 in the tube 44 leading to the IV bag. The subsequent rate of anesthetic delivery is controlled by manipulation of the drip regulator.

As shown in FIGS. 3-6, one embodiment of this invention comprises an adapter 46 mounted on the end of the more-or-less conventional fixture 14. After the fixture 14 is drilled into and embedded in the jaw of the patient, and the drilling member 12 removed, the adapter 46 is coupled to the driven connection 34. The adapter 46 is preferably made of a medical grade polymer and provides an interference fit between the fixture 14 and the adapter 46. To this end, the adapter 46 comprises a body 48 providing a downwardly facing opening 50 of the same cross-sectional shape as the driven connection 34. The opening 50 is slightly tapered from a size slightly larger than the driven connection 34 to a size slightly smaller than the driven connection 34. In this fashion, the adapter 46 may be forced onto the driven connection 34 and thereby make an interference fit and a liquid seal to allow liquid anesthetic to flow through the adapter 46 and the cannula 38 into the patient's jaw.

The liquid seal between the adapter 46 and the fixture 14 is an important feature of this invention and is at least partly due to the elasticity of the medical polymers used in the fixture 14 and in the adapter 46. Although these polymers appear rigid, they are slightly elastic, which promotes the formation of a liquid seal. The commercially available fixtures 14 are currently made of a high density polymer which is more rigid, although still somewhat elastic, when compared to the material of the adapter 46. Although the adapter 46 may be made of any suitable polymer, a preferred material is a homogenous medical grade soft polyvinyl chloride which is considerably elastic. A typical preferred material will have an elongation at break under tension of several times its original dimension. It will accordingly be seen that the liquid seal of this invention is provided, in substantial part, by the elasticity of the homogenous material of the body 48, as contrasted to a separate component such as an O-ring. The liquid seal of this invention is to be contrasted to use of the commercially available fixtures, where anesthetic commonly flows back out of the fixture into the patient's mouth. This reduces the amount of anesthetic that is effective to produce anesthesia of the desired tooth and thereby disrupts any attempt at delivering a controlled or measured amount of anesthetic. In addition, lidocaine and other typical anesthetics taste bad, to which patients object.

The driven connection 34 of the fixture 14 may either have parallel sides or be slightly tapered from a large end adjacent the flange 36 and a small free end. In either event, the opening 50 is tapered slightly more than the driven connection 34 so the driven connection 34 is jammed into, and seals against, the inside of the opening 50.

The adapter 46 also includes a second passage 52 which is illustrated in FIG. 5 as being transverse or lateral to an axis 54 of the fixture 14 although it could be disposed at any suitable angle to the axis 54, such as coincident. The passage 52 is also designed for an interference fit with the tube 44 and is accordingly of tapered, or frustoconical shape, having an outer end slightly greater than the outer diameter of the tube 44 and an inner end slightly smaller than the outer diameter of the tube 44. Accordingly, the tube 44 may be forcibly inserted into the tapered opening 52 and thereby create an interference fit and liquid seal between the adapter 46 and the tube 44. In the embodiment of FIG. 5, the upper surface of the opening 52 is essentially perpendicular to the axis 54 and the lower surface defines an obtuse angle with the axis 54 to provide the taper. In the embodiment of FIG. 5, the uppermost portion of the opening 52 is conveniently coplanar with the end of the passage 50 for purposes more fully apparent hereinafter.

Thus, the tube 44 may be inserted into the opening 52 after the adapter 46 is connected to the fixture 14 or may be inserted before the adapter 46 is attached to the fixture 14. In the alternative, the tube 44 may be adhesively attached to the fixture 46, preferably before the adapter 46 is attached to the fixture 14 or molded onto the fixture 46 at the time of manufacture. An important feature of the adapter 46 is that the nature of the driven connection 34 and the tapered passage 50 allows the adapter 46 to be oriented in the patient's mouth so the tube 44 extends out of the mouth in a desired direction. If placing the adapter 46 on the driven connection 34 shows the tube 44 to be aimed inappropriately, the surgeon may reorient the adapter 46 before forcing it onto the fixture 14.

Another important feature of the adapter 46 is that it allows delivery of anesthetic both by syringe and continuously through the tube 44. It may be desirable, for example, to initially delivery a measured quantity of anesthetic in a conventional manner, i.e. axially down the fixture 14 by inserting a syringe through the passage from which the stylet 24 was removed and then attach the adapter 46 to deliver anesthetic slowly in a substantially continuous manner.

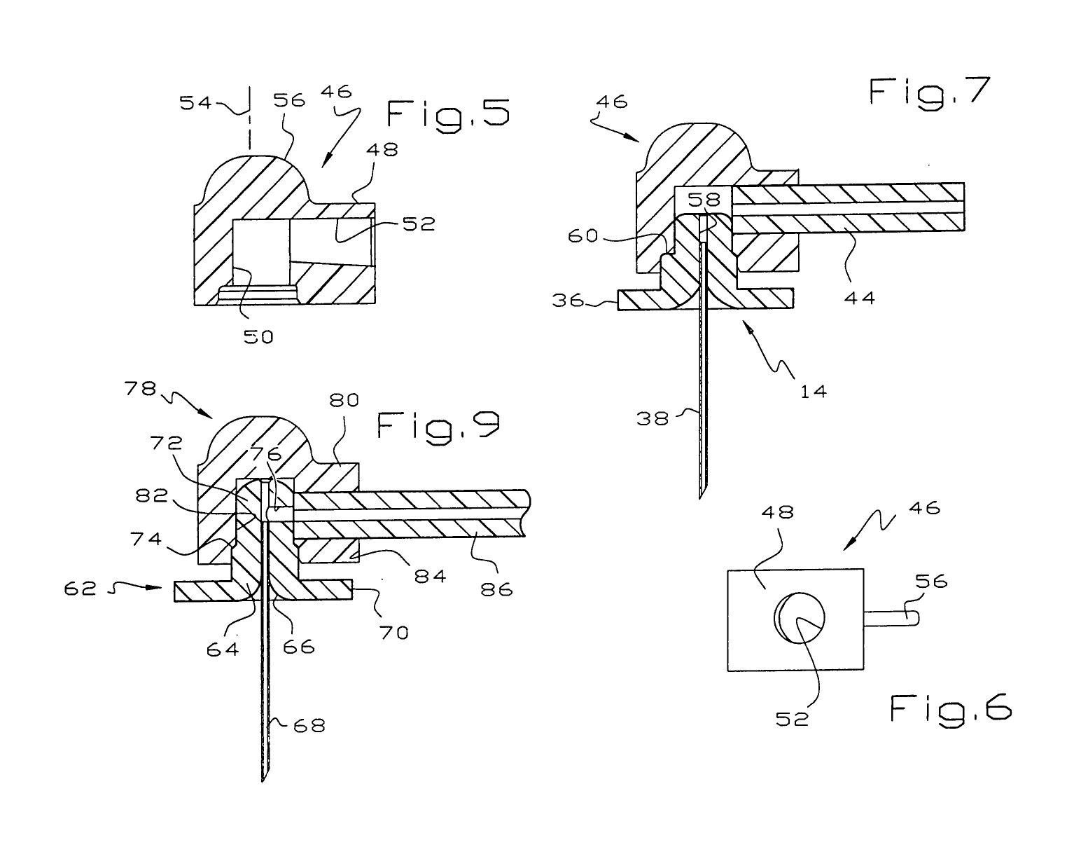

As shown best in FIGS. 5 and 6, the adapter 46 includes an external rib 56 overlying the passage 50. The purpose of the rib 56 is to provide an abutment or shoulder which the surgeon can hold with a suitable instrument, such as a hemostatic clamp, to orient and apply the adapter to the fixture 14.

FIG. 7 illustrates the situation where the adapter 46 has been forced onto the fixture 14 and illustrates that the exit opening of the tube 44 is above the top of the fixture 14, thereby allowing access to the axial passage 58 and ultimately to the cannula 38. To this end, the adapter 46 bottom out, or abuts, a shoulder 60 on the fixture 14. The adapter 46 also seals against the shoulder 60 thereby providing a second liquid seal minimizing leakage of anesthetic through the adapter 46. Those skilled in the art will recognize that the axial passage 58 allows insertion and removal of the stylet 24 and allows insertion and removal of a syringe needle in a conventional intraosseous manner of delivering anesthetic.

Referring to FIGS. 8 and 9, another embodiment of this invention is illustrated. In FIGS. 8 and 9, a fixture 62 is quite similar to the fixture 14 and accordingly includes a body 64 having an axial passage 66 receiving a cannula 68, a flange 70, a driven connection 72 and a shoulder 74. The cannula 68 may be adhesively attached to the body 64, may be press fit or may be molded in place. The fixture 62 differs from the fixture 14 by the provision of a lateral passage 76 opening into the axial passage 66.

An adapter 78 is similar to the adapter 46 and includes a body 80 having a downwardly facing opening 82 designed to provide an interference fit with the driven connection 72 and is thus tapered slightly more than the driven connection 72, as discussed previously. A laterally extending passage 84 provides a connection for a tube 86 either by an interference fit, by use of adhesives or by molding the tube 86 onto the adapter 78. By forcing the adapter 78 onto the fixture 62, a liquid seal is created, along the driven connection 72 and/or at the shoulder 74. In the event it is desirable, a groove (not shown) may be provided on the exterior of the driven connection 72 opening into the lateral passage 76. In this fashion, the tube 86 is in communication with the axial passage 66 in any orientation of the adapter 78 relative to the fixture 62.

After the completion of surgery, the adapter and fixture are removed in a conventional manner. One of the advantages of intraosseous anesthetic delivery is that patients do not exhibit large scale numbness of the face and/or tongue that is typical of larger scale nerve blocking anesthetic procedures.

Another important feature of this invention is that the fixture becomes coupled to the delivery tube. There are times when the fixture is accidentally dislodged from the patient's bone. With the fixture coupled to the delivery tube, the patient cannot swallow or inhale the fixture.

Although the apparatus of this invention has been described as used to deliver anesthetic into a bone during dental surgery, it will be recognized that the apparatus is also useful to deliver other drugs directly into a bone, such as antibiotics in order to manage infection more rapidly or steroids or other antiinflamatory agents to limit swelling and or pain post operatively.

Although this invention has been disclosed and described in its preferred forms with a certain degree of particularity, it is understood that the present disclosure of the preferred forms is only by way of example and that numerous changes in the details of operation and in the combination and arrangement of parts may be resorted to without departing from the spirit and scope of the invention as hereinafter claimed.

1. A method of delivering an anesthetic into a jaw bone adjacent a tooth of a dental surgery patient for inducing anesthesia in the area immediately around the tooth, comprising
drilling a hole in the jaw bone of the patient adjacent the tooth and embedding a fixture in the patient's jaw; and
delivering an anesthetic through the fixture and the hole into the patient's bone substantially continuously from a time preceding the onset of surgery until a time near the end of surgery for inducing and maintaining a profound state of anesthesia during surgery.

2. The method of claim 1 wherein the delivering step comprises pumping anesthetic into the fixture with a powered pump.

3. The method of claim 1 wherein the delivering step comprises connecting a container of anesthetic through a tube connected to the fixture and elevating the container above the hole.

4. The method of claim 1 wherein the delivering step includes delivering an initial measured quantity of anesthetic and then subsequently delivering anesthetic at a rate much smaller than initial measured quantity during a period of at least five minutes.

5. The method of claim 4 wherein the delivering step includes delivering the initial measured quantity of anesthetic with a syringe through a tube connected to the fixture and subsequently delivering anesthetic from a container through the tube.

6. The method of claim 1 wherein the delivering step includes initially delivering about one cubic centimeter of anesthetic and the delivering anesthetic at a rate of not less than about one tenth cubic centimeter during a period of about five minutes.

7. The method of claim 1 further comprising the step of attaching an adapter to the fixture after the drilling step and prior to the delivery step and the delivering step includes delivering anesthetic through the adapter.

8. The method of claim 7 wherein the adapter comprises a generally homogenous polymer body and the attaching step comprises creating an interference fit and liquid seal between the homogenous polymer body and the fixture.

9. The method of claim 8 wherein the adapter comprises a rib and further comprising grasping the rib with a clamp, orienting the adapter on the drive connection and forcing the adapter onto the drive connection.

10. An apparatus for delivering anesthetic into the bone of a surgical patient, comprising
a drilling member including a drill housing, a drive connection for establishing a torque transmitting connection to a dental drilling apparatus and a stylet extending from the drill housing;
a fixture including a body having a driven connection meshing with the drive connection of the drilling member, an axial passage and a cannula coaxial with the axial passage extending from the body for receiving the stylet;
wherein the drive connection is adapted to be removably engaged with the drill housing such that the stylet is inserted into the cannula;
wherein the cannula is adapted to deliver anesthetic to the patient's bone when the sleeve housing and the drill housing are disengaged and the stylet is removed from the hollow sleeve and the cannula is connected to a source of anesthetic;
an adapter comprising a body of homogenous polymer having a tapered opening adapted to receive the driven connection in an interference fit and liquid seal due to the elasticity of the adapter body and driven connection;
a tube attached to the adapter in fluid communication with the cannula for connecting a source of anesthetic to the cannula; and
a continuous source of anesthetic connected to the tube.

11. The apparatus of claim 10 wherein the adapter further comprises a rib providing a shoulder for being clamped by an instrument in order to orient the adapter on the driven connection and apply force to the adapter.

12. The apparatus of claim 10 wherein the adapter provides a tapered passage transverse to the tapered opening and receiving the tube in an interference fit providing a liquid seal.

13. The apparatus of claim 10 wherein the fixture provides a lateral opening and the adapter provides an opening in communication with the lateral opening,

14. The apparatus of claim 10 wherein the driven connection and the tapered opening are of polygonal cross-section.

15. An apparatus for delivering anesthetic into the jaw bone of a surgical patient, comprising
a fixture including a body having a driven polygonal connection meshing with a drive connection of a drilling member, an axial passage and a cannula coaxial with the axial passage extending from the body for receiving a stylet of the drilling member, the cannula being embeddable in the jaw bone of the patient;
an adapter comprising a body of homogenous polymer having a tapered polygonal opening receiving the driven connection in an interference fit and liquid seal due to the elasticity of the adapter body and drive connection; and
a tube attached to the adapter in fluid communication with the cannula for connecting a source of anesthetic to the cannula.

16. The apparatus of claim 15 wherein the adapter further comprises a rib providing a shoulder for being clamped by an instrument in order to orient the adapter on the driven connection and apply force to the adapter.

17. The apparatus of claim 15 wherein the adapter provides a tapered passage transverse to the tapered opening and receiving the tube in an interference fit providing a liquid seal.

18. The apparatus of claim 15 wherein the fixture provides a lateral opening and the adapter provides an opening in communication with the lateral opening.

19. The apparatus of claim 15 further comprising a continuous source of anesthetic connected to the tube.

20. The apparatus of claim 15 wherein the fixture is made of a polymer, the adapter is made of a polymer and the adapter polymer is much more elastic than the fixture polymer.
